(19) United States
(12) Patent Application Publication
(10) Pub. No.: US 2011/0095860 A1
(43) Pub. Date: Apr. 28, 2011

(54) THERMALLY RESPONSIVE SWITCH

(75) Inventor: Isao Higashikata, Aichi (JP)

(73) Assignee: UBUKATA INDUSTRIES CO., LTD., Nagoya-shi, Aichi (JP)

(21) Appl. No.: 12/994,641

(22) PCT Filed: May 30, 2008
(86) PCT No.: PCT/JP2008/001377

§ 371 Date: Nov. 24, 2010

(51) Int. Cl. H01H 37/02

(52) U.S. Cl. 337/298

(57) ABSTRACT

A thermally responsive switch includes a movable contact fixed to an end of a thermally responsive plate and a fixed contact which is conductively connected with a conductive pin through a conductor having a fuse part and a heater part to constitute a pair of switching contacts with the movable contact. The thermally responsive switch is used for disconnecting an AC current flowing to a motor inside a sealed electric compressor. The fixed contact is fixed to an electrically insulating ceramic member disposed between the fixed contact and a sealing container.

### TECHNICAL FIELD

The present invention relates to a thermally responsive switch having a contact switching mechanism using a thermally responsive plate such as a bimetal in a hermetic container.

### BACKGROUND ART

Thermally responsive switches of the above-mentioned type are disclosed in Japanese Patent No. 2519530 (prior art document 1) and Japanese Patent Application Publication JP-A-H10-144189 (prior art document 2) and so on. The thermally responsive switch described in each document comprises a thermally responsive plate provided in a hermetic container including a metal housing and a header plate. A fixed contact is attached via a support to an inner part of the hermetic container. Furthermore, the thermally responsive plate has one end fixed via a support to an inner surface of the hermetic container and the other end to which a movable contact is secured. The movable and fixed contacts constitute a switching contact.

The foregoing thermally responsive switch is mounted in a closed housing of a hermetic electric compressor thereby to be used as a thermal protector for an electric motor of the compressor, as disclosed by Japanese Patent No. 3010141 (prior art document 3), for example. In this case, windings of the motor are connected to the terminal pin or the header plate. The thermally responsive plate reverses the direction of its curvature when a temperature around the thermally responsive switch rises unusually high or when an abnormal current flows in the motor. When the temperature drops to or below a predetermined value, the contacts are re-closed such that the compressor motor is re-energized.

### DISCLOSURE OF THE INVENTION

### Problem to be Overcome by the Invention

The thermally responsive switch is required to open the contacts upon every occurrence of the aforesaid abnormal condition until a refrigerating machine or air conditioner in which the compressor is built reaches an end of product's life. The thermally responsive switch needs to cut off current extremely larger than a rated current of the motor particularly when a motor is driven in a locked rotor condition or when a short occurs between motor windings. When current having such a large inductivity is cut off by the opening of contacts, arc is generated between the contacts, whereupon contact surfaces are damaged by heat due to arc. The welding of contacts occurs when the switching of contacts exceeds a guaranteed operation number. In this regard, in order that an electric path may be cut off even upon occurrence of contact welding for the purpose of preventing secondary abnormality, a part of the electric path needs to be constituted by a heater having a fuse part which is set to be melted down by an extremely large current (see prior art documents 1 and 2), whereby double safety and protective measures need to be taken.

On the other hand, the thermally responsive switches are in many cases mounted inside closed housings of hermetic electric compressors (see prior art document 3). Particularly in lower-capacity compressors, however, a mounting location and a mounting manner need to be determined in view of securement of electrical insulating properties, whereupon a manufacturing process is complicated and costs are increased. As a result, the thermally responsive switches are hard to employ as thermal protectors for hermetic electric compressors.

In view of the above-described-problem, a configuration has now been proposed in which the thermally responsive switch is provided integrally with a hermetic conductive terminal hermetically fixed to the housing of the hermetic electric compressor. In this case, a switching contact of the thermally responsive switch is disposed on one of a plurality of terminal pins hermetically fixed to the hermetic conductive terminal, as disclosed in Japanese Patent Application Publication JP-A-H05-321853 (prior art document 4), for example. Furthermore, the heater having the fuse part as described above is configured as a support for a fixed contact. Consequently, the thermally responsive switch can be reduced in size and employed as a thermal protector for lower-capacity compressors.

However, in the configuration that the heater with the fuse part serves as a support for supporting the fixed contact, nothing can support the fixed contact when the fuse part has been melted down by an extremely larger current. The fixed contact which has been rendered movable in the hermetic container is brought into contact with the hermetic container, thereby having a possibility of forming an electric path.

An object of the disclosure is to provide a thermally responsive switch which can prevent the fixed contact from contact with the hermetic container even when the fuse part supporting the fixed contact has been melted down.

### Means for Overcoming the Problem

The present disclosure provides a thermally responsive switch which is used to interrupt AC current flowing into an electric motor provided in a hermetic electric compressor, the switch comprising a hermetic container including a metal housing and a header plate hermetically secured to an open end of the housing, the housing being formed into a cylindrical shape and having a bottom, a conductive terminal pin inserted through a through hole formed through the header plate and hermetically fixed in the through hole by an electrically insulating filler, a conductive pin inserted through a through hole formed through the bottom of the housing and hermetically fixed in the through hole by the electrically insulating filler, a thermally responsive plate having one of two ends conductively connected and fixed to the conductive terminal pin in the hermetic container, the thermally responsive plate being formed into a dish shape by drawing so as to reverse a direction of curvature thereof at a predetermined temperature, a movable contact secured to the other end of the thermally responsive plate, and a fixed contact fixed via an electrical conductor to the terminal pin in the container, the conductor having a fuse part and a heater, the fixed contact constituting a pair of switching contacts together with the movable contact, characterized in that the fixed contact is fixed to an electrically insulating ceramic member disposed between the container and the fixed contact.

Furthermore, the compressor includes a housing to which a hermetic conductive terminal is fixed, and the header plate is constituted by a part of the terminal, and the container is provided in the housing of the compressor.

Furthermore, the ceramic member is disposed so as to be movable in an axial direction of the terminal pin in the container, and the housing includes a bottom surface further including both lengthwise ends between which the conductive pin is interposed, said both ends of the bottom surface of the housing being deformed axially relative to the conductive pin from an initial state, whereby an operating temperature of the thermally responsive switch is calibratable.

Furthermore, the housing is formed into an elliptic shape that is long in a direction substantially perpendicular to an axial direction of the conductive pin, and the ceramic member is formed into an elliptic shape along with an inner circumferential surface of the housing.

Furthermore, the ceramic member has a recess surrounded by an outer elliptic annular circumferential wall, and the conductor is formed into an elliptic annular shape and located inside the circumferential wall, and the fixed contact is attached to the other end of the conductor in the recess and thereafter fixed to the ceramic member.

### Effect of the Invention

According to the thermally responsive switch, even when the fuse part supporting the fixed contact is melted down, the fixed contact can be prevented from contact with the hermetic container, by the electrically insulating ceramic member disposed between the fixed contact and the hermetic container.

### BRIEF DESCRIPTION OF THE DRAWINGS

FIG. 1 is a longitudinal side section of a thermally responsive switch and its peripheral configuration in accordance with one embodiment;

FIG. 2 is a longitudinal side section of the header plate assembly and the housing assembly;

FIG. 3 is an exploded perspective view of the header plate assembly;

FIG. 4 is a bottom view of the header plate assembly and its periphery;

FIG. 5 is an exploded perspective view of the housing assembly;

FIG. 6 is a plan view of the housing assembly; and

FIG. 7 is a longitudinal side section of an example of hermetically sealed electric compressor.

### EXPLANATION OF REFERENCE SYMBOLS

Reference symbol 1 designates a thermally responsive switch, 2 a hermetic container, 3 a compressor housing (a housing of hermetically sealed electric compressor), 5 an electric motor, 10 a hermetically sealed terminal, 11C a through hole formed in the header plate, 14 a conductive terminal pin, 15 a filler, 19 a hermetic container, 20 a housing, 20A a through hole formed in the bottom of the housing, 21 a header plate portion (header plate), 22 a conductive pin, 29 a thermally responsive plate, a fixed contact, 32 a ceramic member, 32B an outer circumferential wall, 32C a recess, 33 a conductor, 33A a heater, 33B a fuse part and 34 a fixed contact.

### BEST MODE FOR CARRYING OUT THE INVENTION

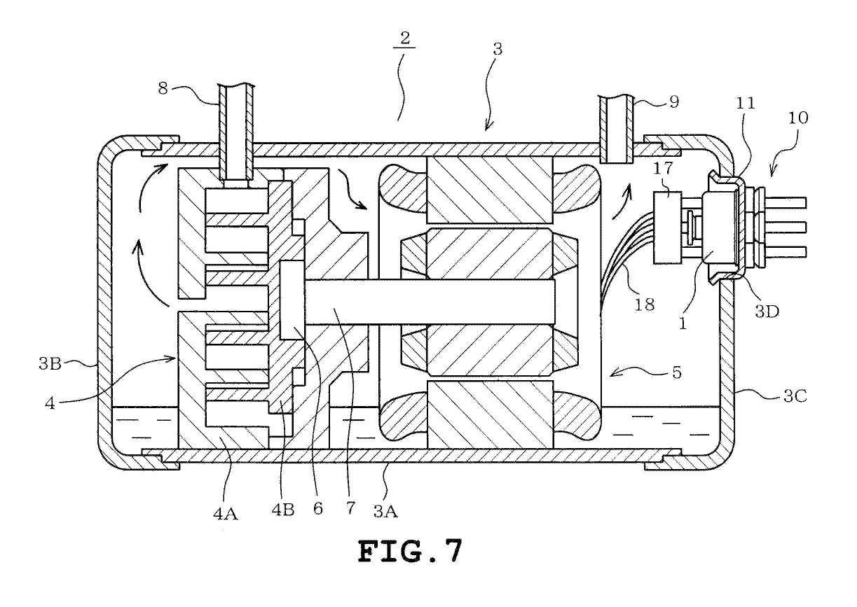

One embodiment will be described with reference to the drawings. FIG. 7 shows an example of horizontal hermetically sealed scroll electric compressor 2 provided with the thermally responsive switch 1. The compressor 2 is of a high-pressure housing type in which an entire compressor housing 3 made of a metal serves as a passage for discharged refrigerant after compression. The compressor housing 3 includes three parts, that is, a central part 3A with both open ends, a housing end cap 3B hermetically covering one end side (the left side as viewed in FIG. 7) of the central part 3A and a housing end cap 3C hermetically covering the other end side (the right side as viewed in FIG. 7) of the central part 3A.

A scroll compressor 4 and an electric motor 5 are accommodated in the compressor housing 3. The scroll compressor 4 is disposed at the housing end cap 3B side in the central part 3A of the compressor housing 3. The motor 5 is disposed at the housing end cap 3C side in the central part 3A of the compressor housing 3. The scroll compressor 4 comprises a fixed scroll 4A and a movable scroll 4B. The movable scroll 4B is driven via a crank 6 and a drive shaft 7 by the motor 5.

A suction pipe 8 and a discharge pipe 9 are provided on an upper part of the compressor housing 3. The suction pipe 8 extends through a part of the compressor housing 3 located at the scroll compressor 4 side to be hermetically fixed in position. The suction pipe 8 is connected to the fixed scroll 4A to supply sucked refrigerant into the scroll compressor 4. The discharge pipe 9 extends through a part of the compressor housing 3 located at the motor 5 side (located on the right of the motor 5, as viewed in. FIG. 7) to be hermetically fixed in position. The refrigerant compressed by the scroll compressor 4 flows in the compressor housing 3 as shown by arrows in FIG. 7 thereby to be supplied through the discharge pipe 9 into a freezing unit (not shown).

The compressor housing 3 has a through hole 3D formed in the housing end cap 3C. A hermetic conductive terminal 10 is hermetically fixed in the hole 3D. The hermetic conductive terminal 10 is provided for electrically connecting an interior and exterior of the compressor housing 3. The thermally responsive switch 1 is provided on the inside of a bottomed cylindrical metal plate 11 constituting the hermetic conductive terminal 10 (or on the inside of the compressor housing 3).

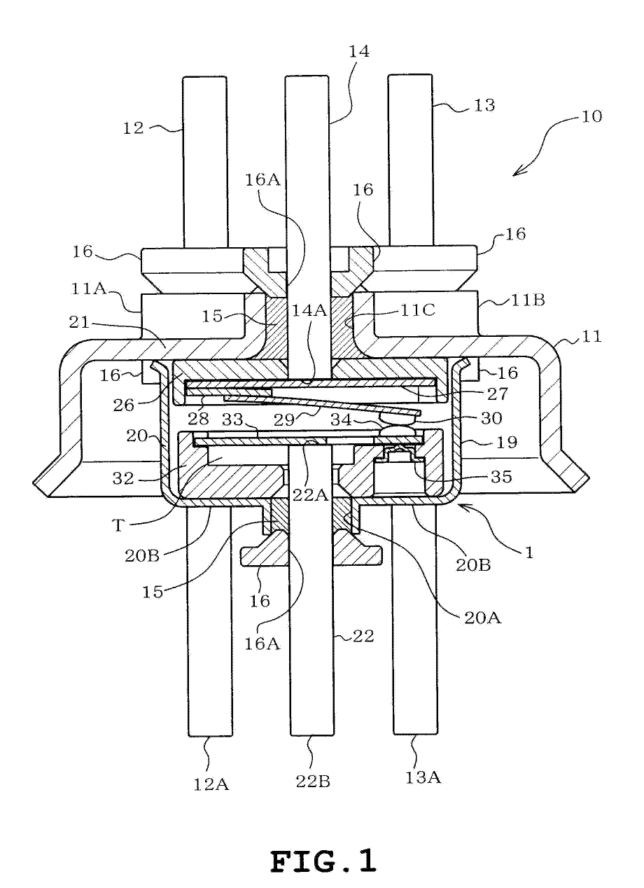

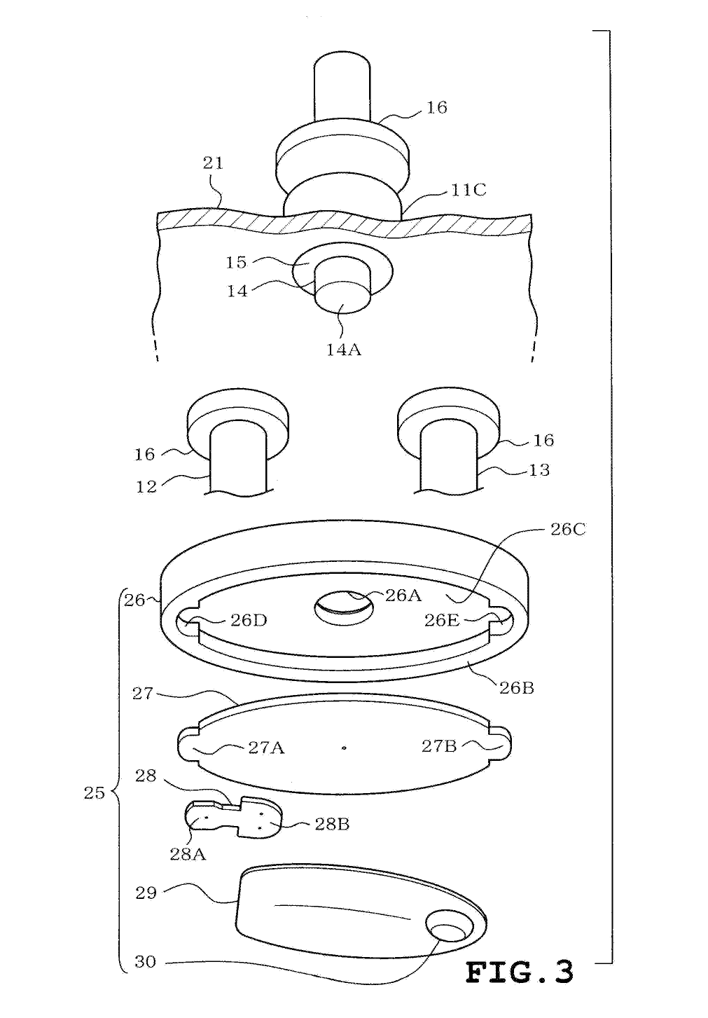

The structure of the thermally responsive switch 1 will now be described with reference to FIGS. 1 to 6. Referring to FIG. 1, the thermally responsive switch 1 and the peripheral structure are shown. The metal plate 11 of the hermetic conductive terminal 10 has a plurality of, for example, three circularly cylindrical through holes 11A to 11C formed by a burring process. Conductive terminal pins 12 to 14 are inserted through the holes 11A to 11C respectively. The terminal pins 12 to 14 are insulated and fixed by an electrically insulating filler 15, such as glass, determined in view of a thermal expansion coefficient by a well known hermetic seal of the compression type. In this case, the holes 11A to 11C are formed so as to extend outward such that a certain thickness of the filler 15 filling the holes 11A to 11c is ensured.

Three heat-resistant inorganic insulating members 16 are tightly fixed to the filler 15 of the terminal pins 12 to 14 respectively. Each insulating member 16 comprises ceramics, zirconia (zirconium oxide) and is formed in view of physical strength such as electrical strength against creeping discharge and heat resistance against sputter. In this case, each insulating member 16 is formed into the shape of a ring having a central insertion hole 16A through which each of the conductive terminal pins 12 to 14 is to be inserted. Furthermore, each of the insulating member 16 disposed on an outer part of the terminal 10 has a circumferential edge cut and raised outward for the purpose of ensuring a creeping distance.

The aforementioned insulating members 16 can improve the dielectric strength between the terminal pins 12-14 and the metal plate 11, whereupon generation and transition of arc can be prevented between the terminal pins 12-14 and the metal plate 11 or between the terminal pins 12-14. Additionally, two other insulating members 16 disposed on an inner part of the terminal 10 are each formed into the shape of a flat ring and have respective central through insertion holes 16A. Furthermore, since the thermally responsive switch 1 is disposed at the side of the inner part of the filler 15 insulating and fixing the terminal pin 14, no insulating member 16 is disposed at the side.

The terminal pins 12 and 13 have respective ends 12A and 13A (ends located at the side of the interior of the compressor housing 3) which are inserted into a socket 17 (see FIG. 7) at the side of the interior of the compressor housing 3. The socket 17 is connected via a lead wire 18 or the like to windings (not shown) of the motor 5. On the other hand, the terminal pin 14 has an end 14A (end located at the side of the interior of the compressor housing 3) which is located in the hermetic container 19 of the thermally responsive switch 1.

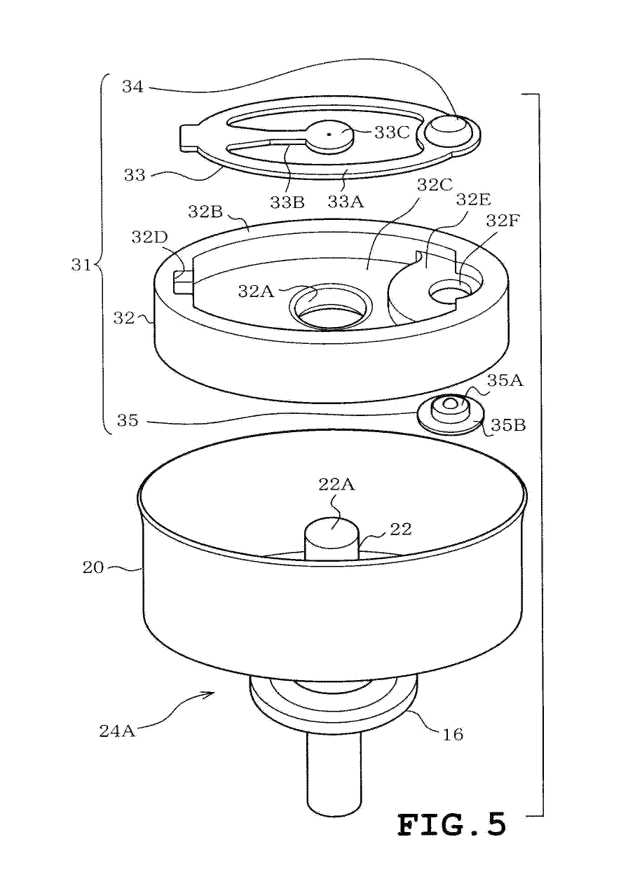

The hermetic container 19 includes a metal housing 20 which is formed so as to have an elliptically cylindrical section and has a bottom and a header plate 21 hermetically secured to an open end of the housing 20 by a ring projection welding or the like. In this case, the housing 20 is formed by drawing a steel sheet or the like by a pressing machine. The housing 20 is formed into an elliptic shape that is long in the direction (a right-left direction in FIG. 1) substantially perpendicular to an axial direction (an up-down direction in FIG. 1) of a conductive pin 20 which will be described later. Thus, the housing 20 is totally formed into a long dome shape (see FIG. 5). Furthermore, the housing 20 has both lengthwise ends which are formed so as to protrude lengthwise into a semicircular section. The header plate 21 is constituted by a part (a peripheral part of the hole 11) of the metal plate 11 of the terminal 10. In this case, the header plate 21 (the entire metal plate 11 including the header plate 21) is formed so as to be thicker than the housing 20.

The housing 20 has a bottom (the bottom of the hermetic container 19) formed with a circularly cylindrical through hole 20A protruding out of the thermally responsive switch 1 (into the compressor housing 3). The hole 20A is formed by the burring process. A conductive pin 22 is hermetically inserted through the hole 20A and insulated and fixed in the hole 20A by the filler 15. Furthermore, another ring-shaped heat-resistant inorganic insulating member 16 having a central insertion hole 16A is tightly fixed to the filler 15 of the conductive pin 22. As a result, the dielectric strength can be improved between the conductive pin 22 and the housing 20, and electric arc generation and transition can be prevented between the conductive pin 22 and the housing 20. The conductive pin 22 has an end 22A located in the hermetic container 19 and the other end 22B (located inside the compressor housing 3) inserted into the socket 17, whereupon the end 22B is connected via the socket 17 to the motor 5.

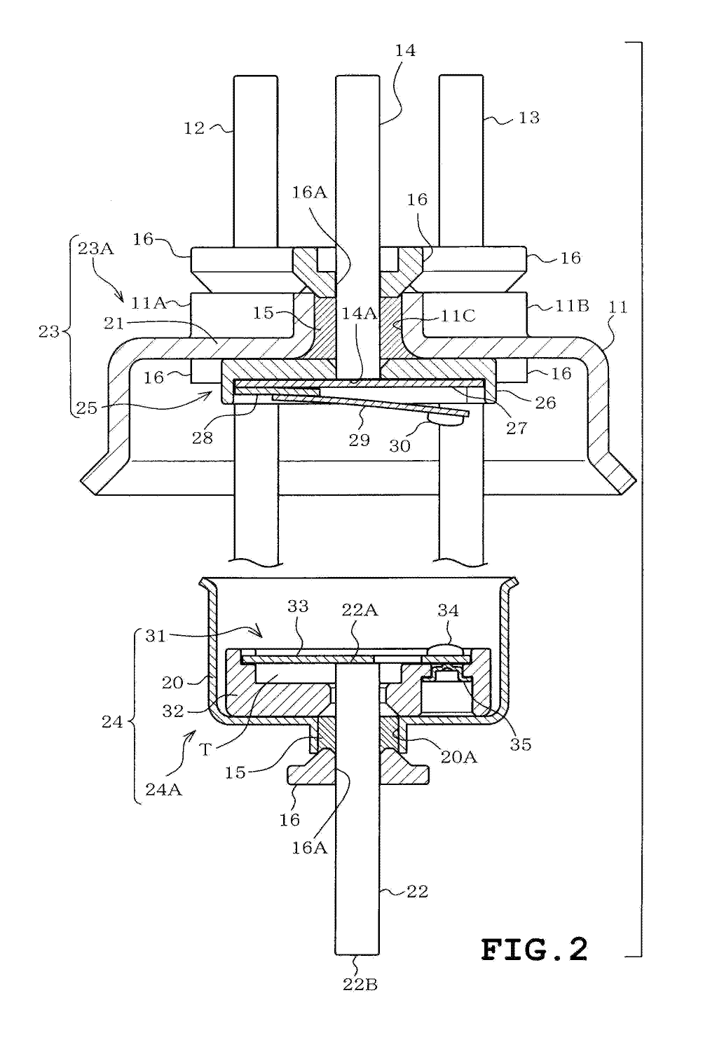

The thermally responsive switch 1 comprises a header plate assembly 23 and a housing assembly 24 as shown in FIG. 2. The header plate assembly 23 comprises a header plate subassembly 23A and a movable contact assembly 25. In the header plate subassembly 23A, the hole 11C is formed through the metal plate 11 of the terminal 10, and the terminal pin 14 is inserted through and hermetically fixed in the hole 11C by the filler 15. The movable contact assembly 25 comprises a ceramic member 26, a metal base plate 27, a metal support 28, a thermally responsive plate 29 and a movable contact 30.

The ceramic member 26 is formed into an elliptic shape conforming to the inner peripheral surface of the housing 20 and has a centrally located insertion hole 26A through which the terminal pin 26A is inserted. The ceramic member 26 further has an elliptically annular outer peripheral wall 26B conforming to a periphery of the ceramic member 26 and an elliptic recess 26C surrounded by the outer peripheral wall 26B. The outer peripheral wall 26B has both lengthwise ends with notches 26D and 26E both formed by cutting out the ends respectively.

The base plate 27 is formed into an elliptic shape and has a substantially entire recess 26C of the ceramic member 26. The terminal pin 14 has an end 14A which is connected and fixed via the ceramic member 26 to a central part of the base plate 27 by the welding or the like. Furthermore, the base plate 27 has both lengthwise ends formed with protrusions 27A and 27B which protrude lengthwise. The protrusions 27A and 27B are adapted to be fitted into the notches 26D and 26E respectively.

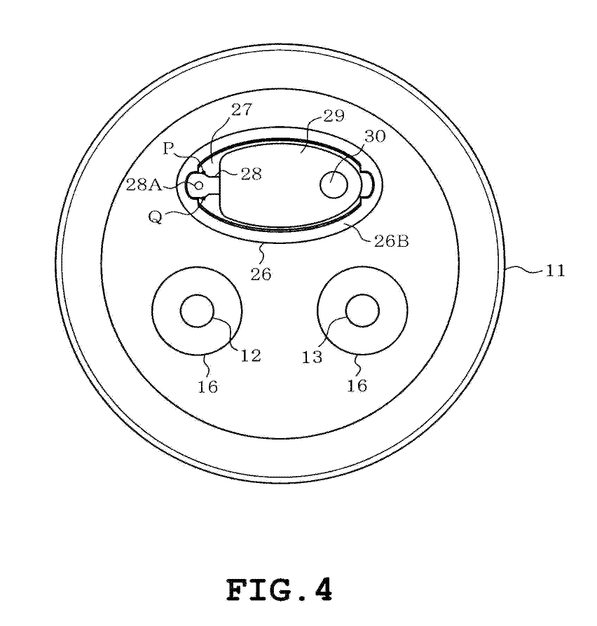

The support 28 has a weld portion 28A extending lengthwise and another weld portion 28B extending in a direction perpendicular to the lengthwise direction and having a larger width than the weld portion 28A. The weld portion 28B is provided so as to be slightly inclined downward relative to the weld portion 28A. The weld portion 28A is secured to the protrusion 27A of the base plate 27 by welding, and the weld portion 28B is secured to an end of the thermally responsive plate 29 by welding. In this case, the weld portion 28A is welded by causing electric current to flow between the weld portion 28A and two points P and Q interposing the weld portion 28A on the base plate 27, as shown in FIG. 4.

The thermally responsive plate 29 is totally formed into a substantially elliptic shape and has a straight portion formed by cutting off an end thereof. The straight portion extends in a direction perpendicular to the lengthwise direction of the thermally responsive plate 29. The thermally responsive plate 29 includes a part which is near the straight portion and is to be welded to the aforementioned weld portion 28B. The thermally responsive plate 29 is formed by drawing a thermally deformable material such as bimetal or trimetal into the shape of a shallow dish. The thermally responsive plate 29 is set to reverse its curvature with snap action when reaching a predetermined temperature. The thermally responsive plate 29 is disposed in the elliptic recess 26C with a space being defined between the outer peripheral wall 26B of the ceramic member 26 and the thermally responsive plate 29 as shown in FIG. 4.

The movable contact 30 is secured to the other end of the thermally responsive plate 29 by welding. The movable contact 30 contains a metal oxide and is formed into the shape of a disc. The movable contact 30 has a slightly convex contact surface (spherical surface).

The header plate assembly 23 comprising the above-described members will be assembled as follows. Firstly, the ceramic member 26 is arranged opposite the header plate 21 (a part of the metal plate 11 including the terminal pin 14 and the filler 15) with the terminal pin 14 being inserted into the insertion hole 26A. Secondly, the base plate 27 is placed in the recess 26C of the ceramic member 26, and a central part of the base plate 27 is welded to the end 14A of the terminal pin 14. Subsequently, the weld portion 28B of the support 28 is welded near the straight portion of the thermally responsive plate 29 to which the movable contact 30 has been welded. As a result, the header plate assembly 23 comprising the header plate 21 and the movable contact assembly 25 is thus assembled. In the embodiment, the thermally responsive plate 29 is welded and fixed via the support 28 to the base plate 27. However, the thermally responsive plate 29 may directly be fixed to the base plate 27 when the characteristics of the thermally responsive plate 29 are not adversely affected.

The housing assembly 24 will now be described. The housing assembly 24 includes a housing subassembly 24A and a fixed contact assembly 31 accommodated in the housing subassembly 24A as shown in FIG. 2. In the housing subassembly 24A, the conductive pin 22 is inserted through the hole 20A provided in the housing 20 and fixed in position by the filler 15. The fixed contact assembly 31 comprises a metal electrical conductor 33, a fixed contact 34, a metal holder 35. The conductor 33 provided with the fixed contact 34 is fixed to the ceramic member 32 by a holder 35.

The ceramic member 32 is formed into an elliptic shape conforming to the inner circumferential surface of the housing 20 and has in a central part thereof an insertion hole 32A through which the conductive pin 22 is inserted. The insertion hole 32A has a larger diameter than the conductive pin 22, whereby the ceramic member 32 is adapted to be disposed so as to be movable in the housing 20 (the hermetic container 19) in the axial direction of the conductive pin 22. Furthermore, the ceramic member 32 has an elliptically annular outer peripheral wall 32B and a recess 32C surrounded by the outer peripheral wall 32B. The ceramic member 32 has a notch 32D formed in one end of the recess 32C (the left side as viewed in FIG. 5) by lengthwise cutting out the part thereof. On the other hand, the other end of the recess 32C (the right side as viewed in FIG. 5) is formed with a stepped portion 32E inwardly extending in an arc shape toward the center of the recess 32C. The stepped portion 32E has an insertion hole 32F formed substantially in the middle thereof so that a protrusion 35A of the holder 35 which will be described later is insertable into the insertion hole 32F.

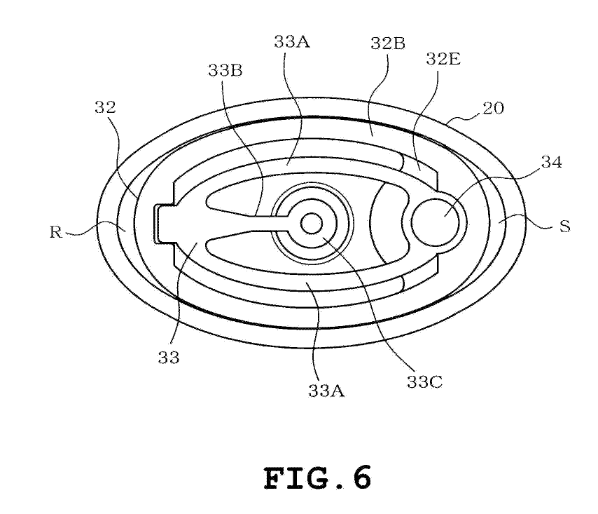

The ceramic member 32 is adapted to be disposed while a substantially entire side periphery thereof (the part other than both lengthwise ends) is in abutment with the inner peripheral surface of the housing 20, as shown in FIG. 6. Thus, the movement of the ceramic member 32 is limited by the inner peripheral surface of the housing 20 such that the ceramic member 32 is disposed in the housing 20 (the hermetic container 19) so as to be unrotatable. In this case, spaces R and S are defined between the lengthwise ends of the ceramic member 32 and the lengthwise ends of the housing 20 respectively.

The conductor 33 has a heater part 33A and a fuse part 33B both of which are formed integrally therewith. The heater part 33A is formed into an elliptically annular shape which is smaller than the outer peripheral wall 32B of the ceramic member 32. The heater part 33A is disposed in the recess 32C of the ceramic member 32 with spaces being defined between the outer peripheral wall 32B and the heater portion 33A as shown in FIG. 6. The heater part 33A is adapted to be disposed substantially in parallel to the thermally responsive plate 29 in the condition where the housing assembly 24 has been assembled to the header plate assembly 23, as shown in FIG. 1, whereupon the heat generated by the heater part 33A is efficiently transferred to the thermally responsive plate 29.

The fuse part 33B extends from one end of the heater part 33A toward the central part of the heater 33A. The fuse part 33B has a distal end connected and fixed to the end 22A of the conductive pin 22. As a result, the fuse part 33B constitutes a part of an electrical path formed between the terminal pin 14 and the conductive pin 22 (an electrical path formed by the terminal pin 14, base plate 27, support 28, thermally responsive plate 27, movable contact 30, fixed contact 34, conductor 33 and conductive pin 22). Furthermore, the fuse part 33B has a smaller sectional area than the heater part 33A.

The fixed contact 34 is secured to the other end of the conductor 33 by welding so as to be located opposite the movable contact 30. The fixed contact 34 contains a metal oxide and is formed into the shape of a disc. The fixed contact 34 has a slightly convex contact surface (spherical surface).

The holder 35 has a bottom circular cylindrical protrusion 35A and an annular flange 35B provided around an open end of the protrusion 35A. The holder 35 is inserted into the insertion hole 32F of the ceramic member 32 from the backside, and the other end of the conductor 33 is welded to the protrusion 35A. As a result, the fixed contact 34 welded to the other end of the conductor 33 is adapted to be fixed to the other end of the ceramic member 32 (an upper part of the stepped portion 32E).

The housing assembly 24 comprising the above-described members is assembled as follows. Firstly, the conductor 33 with the other end to which the fixed contact 34 is welded is placed in the recess 32C of the ceramic member 32. Subsequently, the holder 35 is welded to the other end of the conductor 33 from the backside of the ceramic member 32, whereby the fixed contact 34 is fixed to the other end of the ceramic member 32. The ceramic member 32 to which the fixed contact 34 has been fixed is disposed in the housing 20 with the conductive pin 22 being inserted into the insertion hole 32A. A circular distal end 33C formed on the fuse part 33B of the conductor 33 is then welded to the end 22A of the conductive pin 22, whereby the housing assembly 24 comprising the housing 20 and the fixed contact assembly 31 is assembled. The fixed contact 34 is indirectly supported by the fuse part 33B in the housing assembly 24. Furthermore, a space T is defined between the upper surface of the recess C and the conductor 33 as shown in FIGS. 1 and 2.

The header 21 of the header plate assembly 23 and an open end of the housing 20 of the housing assembly 24 are hermetically welded together while the interior of the container 19 is filled with a gas with a predetermined pressure, whereby the thermally responsive switch 1 is assembled. The ceramic member 26 is disposed between the movable contact 30 and the hermetic container 19 in the thermally responsive switch 1 (particularly, peripheries of the header plate 21 and the open end of the housing 20). Furthermore, the ceramic member 32 is disposed between the fixed contact 34 and the container 19 (particularly, the bottom of the housing 20 and the periphery thereof).

A switching contact comprising the movable contact 30 and the fixed contact 34 is formed between the terminal pin 14 and the conductive pin 22 in the interior of the thermally responsive switch 1. When the temperature of the refrigerant is abnormally high in the interior of the compressor 2 or when an abnormal current flows in the motor 5 or in another case, the thermally responsive plate 29 reverses its curvature to open the contacts 30 and 34, thereby interrupting electric supply to the motor 5. Furthermore, when the temperature of the refrigerant or the current value of the motor 5 is reduced to or below a predetermined value such that the interior temperature of the switch 1 drops, the contacts 30 and 34 are re-closed so that the motor 5 is energized.

The fuse part 33B is not melted down during a normal operation of the scroll compressor 4 which is equipment to be controlled. Furthermore, when the motor 5 is in a locked rotor condition, heat generated by the heater part 33B reverses the thermally responsive plate 29 in a short period of time to open the contacts 30 and 34. In this case, too, the fuse part 33B does not melt. However, when the thermally responsive switch 1 repeats switching of the contacts 30 and 33B over a guaranteed number of times of operation, the movable and fixed contacts 30 and 34 adhere to each other such that the movable and fixed contacts 30 and 34 cannot sometimes be separated from each other. When the rotor of the motor 5 is locked in this case, an excessive current raises the temperature of the fuse part 33B thereby to melt down the fuse part 33B, whereupon the motor 5 can reliably be interrupted.

A calibration process will be described in which a reversing temperature of the thermally responsive switch 29 is calibrated after assembly of the thermally responsive switch 1. The bentness of the thermally responsive plate 29 after the drawing process varies due to differences in the characteristics of the thermally responsive plate 29, machining variance resulting from the drawing process, and the like. Furthermore, the shape and dimensions of the thermally responsive switch 1 vary due to welding or the like during manufacture of the header plate assembly 23 and the housing assembly 24 and during assembly of the thermally responsive switch 1. Still furthermore, the thermally responsive switch 1 slightly varies in the shapes of components constituting the header plate assembly 23 and the housing assembly 24. As a result, a contact pressure between the movable and fixed contacts 30 and 34 constituting the switching contact needs to be adjusted so that a reversing temperature of the thermally responsive plate 29 is calibrated into a desired specified value.

In the calibrating process, calibrating portions 20B of the bottom of the housing 20 (the hermetic container 19) are deformed in the axial direction of the conductive pin 22 from initial shapes in oil maintained at the specified reversing temperature until the curvature of the thermally responsive plate 29 is reversed, respectively. The calibrating portions 20B refer to both lengthwise ends of the bottom of the housing 20 with the conductive pin 22 being interposed therebetween as shown in FIG. 1, respectively. In this case, the calibrating portions 20B of the housing 20 are collapsed from outside the housing 20 (collapsing temperature adjustment).

When both bottom ends (the calibrating portions 20B) of the housing 20 are thus deformed in the axial direction of the conductive pin 22, the fixed contact 34 and the ceramic member 32 are moved in parallel to each other in the axial direction of the conductive pin 22, whereby the reversing temperature of the thermally responsive plate 29 is calibrated. In this case, the fuse part 33B is inclined downward between one end of the conductor 33 and the end 22A of the conductive pin 22. However, since the space T is defined between the upper surface of the recess 22C of the ceramic member 32 and the conductive member 33, the fuse part 33B is hard to come into contact with the ceramic member 32 (in particular, the upper surface of the recess 32C) after calibration.

According to the thermally responsive switch 1 described above, the fixed contact 34 is fixed to the electrically insulating ceramic member 32 disposed between the hermetic container 19 and the fixed contact 34. As a result, even if an excessive current melts down the fuse part 33B indirectly supporting the fixed contact 34, the ceramic member 32 can prevents the fixed contact 34 from contacting the hermetic container 19.

Furthermore, the header plate 21 comprises a part of the hermetically sealed conductive terminal 10 hermetically fixed to the housing of the hermetic electric compressor (the compressor housing 3). The hermetic container 19 of the thermally responsive switch 1 is provided in the interior of the compressor housing 3. According to the construction, since the terminal 10 and the thermally responsive switch 1 are formed integrally with each other, a conventionally required work of mounting the thermally responsive switch 1 can be eliminated, and a work of connecting the terminal 10 outside the compressor 2 can be eliminated. Furthermore, since the connection between the thermally responsive switch 1 and the terminal 10 is disposed in the compressor housing 3, the reliability of the thermally responsive switch 1 and according the compressor 2 can be improved.

Furthermore, the thermally responsive switch is operated only by the current flowing in the electric motor 5 in the construction that the thermally responsive switch is disposed outside the compressor 2. On the other hand, since the thermally responsive switch 1 is disposed inside the compressor 2, the thermally responsive switch 1 is operated in response to the temperature of refrigerant in the compressor 2 as well as by the current flowing in the electric motor 5 in the embodiment, whereupon the thermally responsive switch 1 can function as a further accurate thermal protector.

The ceramic member 32 is movable in the axial direction of the conductive pin 22 in the hermetic container 19 of the thermally responsive switch 1. The operating temperature of the thermally responsive switch 1 is calibratable by deforming the calibrating portions 20B in the bottom of the housing 20 in the axial direction of the conductive pin 22 from the initial shape. According to the construction, when the calibrating portion 32B is deformed in the axial direction of the conductive pin 22 from the initial shape, the operating temperature is calibratable while the fixed contact 34 and the ceramic member 32 are moved in parallel to each other. As a result, angular variations of the fixed contact 34 to the movable contact 30 with the operating temperature calibration can be reduced, whereupon the operating temperature can be calibrated more accurately.

The housing 20 is formed into the elliptic shape and is long in the direction substantially perpendicular to the axial direction of the conductive pin 22. The ceramic member 32 is formed into an elliptic shape conforming to the inner peripheral surface of the housing 20. According to the construction, the ceramic member 32 is limited by the inner peripheral surface of the housing 20 thereby to be unrotatable in the hermetic container 19. As a result, even when the fuse part 33B has been melted down, the fixed contact 34 is rendered unrotatable together with the ceramic member 32. This renders the fixed contact 34 unrotatable together with the ceramic member 32, whereupon the contact of the fixed contact 34 with the hermetic container 19 can further be reduced.

The ceramic member 32 has the recess 32C surrounded by the elliptically annular outer peripheral wall 32B. The conductor 33 is formed into the elliptically annular shape so as to be located inside the outer peripheral wall 32B. The fixed contact 34 is attached to the other end of the conductor 33 and then fixed to the ceramic member 32. According to the construction, since the fixed contact 34 and the conductor 33 are surrounded by the outer peripheral wall 32B, not only the fixed contact but also the heater 33A of the conductor 33 remaining after the meltdown can be prevented from the contact with the hermetic container 19.

The above-described embodiment should not be restrictive but may be modified or expanded as follows, for example. A fuse directly supporting the fixed contact 34 in the hermetic container 19 may be provided instead of the fuse part 33B constituting a part of the conductor 33.

The housing 20 should not be limited to the long dome shape with the elliptically cylindrical section. For example, when a predetermined strength can be obtained by provision of ribs in the lengthwise direction of the housing 20 or the like, the housing 20 may or may not be formed into the long dome shape with the elliptically cylindrical section.

The ceramic member 32 should not be limited to the elliptic shape conforming to the inner peripheral surface of the housing 20. For example, the ceramic member 32 may be formed into a semielliptical shape and occupy a half area of the housing 20. Furthermore, although the ceramic member 32 is formed so that a substantially entire side periphery thereof is in abutment with the inner peripheral surface of the housing 20, the ceramic member 32 should not be limited to the construction. For example, a part of the side periphery of the ceramic member 32 may be supported by a support pin provided on the housing 20 or the like so as to be unrotatable in the hermetic container 19.

Furthermore, when the housing 20 or the ceramic member 32 has been deformed, the other members (the conductor 33 and the like) may be deformed according to the shape of the deformed housing 20 or the ceramic member 32.

The calibration of the reversing temperature of the thermally responsive plate 29 can be executed using a pressing apparatus provided with a holding portion which holds the housing 20 and a temperature adjusting head which presses the calibrating portions 20B of the housing 20 held by the holding portion.

The heat-resistant inorganic insulating members 16 may or may not be provided. The insulating members 16 may be eliminated when a sufficient creeping distance can be obtained on the surface of the filler 15 or when the thermally responsive switch 1 is used in an environment where substantially no smudge inhibiting insulation adheres to the thermally responsive switch 1.

Two or more pairs of switching contacts including the movable contacts 30 and the fixed contacts 34. Furthermore, the movable and fixed contacts 30 and 34 may be formed into a crossbar contact in which the movable and fixed contacts 30 and 34 are normal to each other. In this construction, a sufficient contact pressure can be obtained between the contacts even when current is small.

The thermally responsive switch 1 may be used in a vertical hermetically sealed electric compressor as well as in the horizontal hermetically sealed scroll electric compressor 2. Additionally, the thermally responsive switch 1 may be provided in a low-pressure housing type hermetically sealed electric compressor in which the motor 5 is disposed in a low-pressure area serving as a suction side and the scroll compressor 4 is disposed in a high-pressure area serving as a discharge side.

### INDUSTRIAL APPLICABILITY

As described above, in a thermally responsive switch in which a conductor having a fuse part serves as a support which supports a fixed contact, the fixed contact can be prevented from contacting a hermetic container even when the fuse part melts down. Accordingly, the thermally responsive switch is useful particularly as a thermal protector for hermetically sealed electric compressors with a small capacity.

1. A thermally responsive switch which is used to interrupt AC current flowing into an electric motor provided in a hermetic electric compressor, the switch comprising:
a hermetic container including a metal housing and a header plate hermetically secured to an open end of the housing, the housing being formed into a cylindrical shape and having a bottom;
a conductive terminal pin inserted through a through hole formed through the header plate and hermetically fixed in the through hole by an electrically insulating filler;
a conductive pin inserted through a through hole formed through the bottom of the housing and hermetically fixed in the through hole by the electrically insulating filler;
a thermally responsive plate having one of two ends conductively connected and fixed to the conductive terminal pin in the hermetic container, the thermally responsive plate being formed into a dish shape by drawing so as to reverse a direction of curvature thereof at a predetermined temperature;
a movable contact secured to the other end of the thermally responsive plate; and
a fixed contact fixed via an electrical conductor to the terminal pin in the container, the conductor having a fuse part and a heater, the fixed contact constituting a pair of switching contacts together with the movable contact,
wherein the fixed contact is fixed to an electrically insulating ceramic member disposed between the container and the fixed contact.

2. The thermally responsive switch according to claim 1, wherein:
the compressor includes a housing to which a hermetic conductive terminal is fixed;
the header plate is constituted by a part of the terminal; and
the container is provided in the housing of the compressor.

3. The thermally responsive switch according to claim 1, wherein:
the ceramic member is disposed so as to be movable axially relative to the terminal pin in the container; and
the housing includes a bottom surface further including both lengthwise ends between which the conductive pin is interposed, said both ends of the bottom surface of the housing being deformed axially relative to the conductive pin from an initial state, whereby an operating temperature of the thermally responsive switch is calibratable.

4. The thermally responsive switch according to claim 2, wherein:
the ceramic member is disposed so as to be movable axially relative to the terminal pin in the container; and
the housing includes a bottom surface further including both lengthwise ends between which the conductive pin is interposed, said both ends of the bottom surface of the housing being deformed axially relative to the conductive pin from an initial state, whereby an operating temperature of the thermally responsive switch is calibratable.

5. The thermally responsive switch according to claim 1, wherein:
the housing is formed into an elliptic shape that is long in a direction substantially perpendicular to an axial direction of the conductive pin; and
the ceramic member is formed into an elliptic shape along with an inner circumferential surface of the housing.

6. The thermally responsive switch according to claim 2, wherein:
the housing is formed into an elliptic shape that is long in a direction substantially perpendicular to an axial direction of the conductive pin; and
the ceramic member is formed into an elliptic shape along with an inner circumferential surface of the housing.

7. The thermally responsive switch according to claim 3, wherein:
the housing is formed into an elliptic shape that is long in a direction substantially perpendicular to an axial direction of the conductive pin; and
the ceramic member is formed into an elliptic shape along with an inner circumferential surface of the housing.

8. The thermally responsive switch according to claim 4, wherein:
the housing is formed into an elliptic shape that is long in a direction substantially perpendicular to an axial direction of the conductive pin; and
the ceramic member is formed into an elliptic shape along with an inner circumferential surface of the housing.

9. The thermally responsive switch according to claim 1, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

10. The thermally responsive switch according to claim 2, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

11. The thermally responsive switch according to claim 3, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

12. The thermally responsive switch according to claim 4, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

13. The thermally responsive switch according to claim 5, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

14. The thermally responsive switch according to claim 6, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

15. The thermally responsive switch according to claim 7, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.

16. The thermally responsive switch according to claim 8, wherein:
the ceramic member has a recess surrounded by an outer elliptic annular circumference wall;
the conductor is formed into an elliptic annular shape and located inside the circumferential wall; and
the fixed contact is attached to the other end of the conductor and thereafter fixed to the ceramic member in the recess.
